(19) United States
(12) Patent Application Publication
(10) Pub. No.: US 2014/0337098 A1
(43) Pub. Date: Nov. 13, 2014

(54) SYSTEM AND METHOD FOR TIME OF PURCHASE CONSUMER SURVEY

(71) Applicant: QUALCOMM INCORPORATED, San Diego, CA (US)

(72) Inventors: Shriram GANESH, Mountain View, CA (US); Jose MENENDEZ, San Diego, CA (US)

(73) Assignee: QUALCOMM Incorporated, San Diego, CA (US)

(21) Appl. No.: 13/890,783

(22) Filed: May 9, 2013

(51) Int. Cl. G06Q 30/02

(52) U.S. Cl. CPC G06Q 30/0203
USPC 705/7.32

(57) ABSTRACT

A method and system are described for conducting a consumer survey during a checkout process at a retailer location with a consumer who is associated with a portable computing device (“PCD”). A survey ID associated with a time of purchase (“TOP”) survey is presented as a QR code to the consumer during the checkout process. Based on the survey ID, provision of a TOP survey is initiated. Survey content is selected and pushed to the PCD. The survey content may have been preselected or may be dynamically selected based on factors including, but not limited to, recognition of items being scanned during the checkout process, responses to previously pushed survey content, historical purchasing patterns of the consumer, time of day, etc. Provisioning of a TOP survey may end at the conclusion of the checkout process so that the consumer can complete payment and leave the retail location.

### BACKGROUND

Portable computing devices (“PCDs”), such as cellular telephones and other “smart” devices, have become ubiquitous in today's society. And, due to the inherent portability of most PCDs, a consumer's personal PCD may be easily carried along just about anywhere. Consequently, a PCD may be used as a real time interface to a consumer during, or near the conclusion of, a shopping experience.

The fact that many consumers carry PCDs with them may benefit retailers as well as manufacturers of the products they sell. Retailers and manufacturers have long sought for ways to trend consumer habits, track consumer behavior and document consumer feedback so that, ultimately, the gained knowledge could be exploited in the quest for increased sales. A popular way to gather such knowledge has traditionally been a survey.

Commonly, retailers offer survey links on receipts in an effort to gather valuable consumer feedback. In offering the survey link, perhaps along with an incentive of some kind (such as “fill out the survey at http:// . . . and get a $50 rebate” or “fill out the survey at http:// . . . and get entered to win a $50 gift card”), the retailer hopes that the consumer will not only remember the survey opportunity but actually take the time to participate in the survey. The reality is, however, that the incentives are often outweighed by the disincentives of having to later dig up the receipt (assuming that a receipt was kept in the first place), input the link in a browser at home, provide all the required receipt information and fill out the survey.

Certainly, in some cases the receipt may have a quick response (“QR”) code to ease the inherent inconvenience of the survey process for the consumer; however, for many consumers filling out a survey on a PCD after a receipt has been generated (i.e., after the purchase transaction has been completed) is unlikely because the consumer needs to get out of the way of the next customer and move on with his busy schedule. Consequently, a small percentage of consumers actually participate in surveys, and those who do may be only the ones who had either an awful shopping experience or an exemplary one. Also, because the survey completion rate is relatively low for consumers who fill out surveys provisioned by current systems and methods after the purchase transaction, the data gathered may not represent the average shopper's opinion.

Therefore, what is needed is a system and method for efficiently provisioning consumer surveys at a time that is convenient for the consumer and at a time that ensures accurate and useful feedback for the retailer. More specifically, what is needed is a system and method for provisioning a consumer survey during the checkout process via a PCD associated with the consumer.

### SUMMARY OF THE DISCLOSURE

A method and system are described for conducting a consumer survey during a checkout process at a retailer location with a consumer who is associated with a portable computing device (“PCD”). An exemplary method comprises presenting a survey ID in the form of a machine readable code, such as a quick response (“QR”) barcode, associated with a time of purchase (“TOP”) survey to the consumer during the checkout process and, based on the survey ID, initiating provision of the TOP survey. Other methods may receive plain text entries from the user or merchant, such as a personal identification number (“PIN”), to trigger a TOP survey. Regardless of how the TOP survey is triggered, survey content is selected and pushed to the PCD associated with the consumer. The survey content may have been preselected or may be dynamically selected based on any number of factors including, but not limited to, recognition of items being scanned for purchase or return during checkout process, responses to previously pushed survey content, historical purchasing patterns of the consumer, time of day, etc. Provisioning of a TOP survey may end at the conclusion of the checkout process so that the consumer can complete payment and leave the retail location.

An exemplary system for provisioning a TOP survey includes a survey server in communication with a PCD associated with the consumer and the point of sale (“POS”) system associated with the retailer. The POS system includes a component for presenting a QR code to the consumer during the checkout process. Using the PCD, the user may scan the QR code to initiate communication with the survey server. In other embodiments, a loyalty account token of the consumer may be used by the survey server to identify a phone number associated with the PCD so that a text including a weblink may be sent via short messaging service (“SMS”) to the PCD. In still other embodiments, an application running on the PCD may receive a push notification from the survey server that includes a weblink or other survey content. Once the PCD and the survey server are in communication, survey content associated with a TOP survey may be pushed to the PCD from the server and responses to the survey content pushed back to the server from the PCD. In some embodiments, functionality of the survey server may be integrated into the POS. In other embodiments, functionality may be shared between the POS and the survey server.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a high level diagram illustrating exemplary components of a system for provisioning a time of purchase (“TOP”) survey to a consumer in a retail location.

FIG. 2 is a diagram of exemplary computer architecture for the system illustrated in FIG. 1.

FIG. 3 illustrates an exemplary method for provisioning a TOP survey to a consumer during a checkout procedure in a retail location.

FIG. 4 illustrates an exemplary method for provisioning a TOP survey to a consumer with an associated loyalty account during a checkout procedure in a retail location.

FIG. 5 illustrates an exemplary method for provisioning a dynamic TOP survey to a consumer during a checkout procedure in a retail location.

FIG. 6 is a diagram of an exemplary, non-limiting aspect of a portable computing device (“PCD”) comprising a wireless telephone which corresponds with FIG. 1 and FIG. 2.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed. Further, an “application” may be a complete program, a module, a routine, a library function, a driver, etc.

The term “content” may also include files having executable content, such as: object code, scripts, byte code, markup language files, and patches. In addition, “content” referred to herein, may also include files that are not executable in nature, such as documents that may need to be opened or other data files that need to be accessed, transmitted or rendered. For example, in this description, reference to “survey content” may include survey questions or other survey related data pushed to a consumer PCD or, in some embodiments, requested by a consumer PCD. Similarly, answers to survey questions or other responses (or even non-responses) generated by a user of a PCD may also be considered “survey content” depending on the context.

In this description, the term “QR code” is used generally to refer to any type of matrix barcode (or multi-dimensional bar code) or trigger to a TOP survey and is not meant to limit the scope of any embodiment to the use of the specific type of barcode understood in the art to be a quick response code. That is, it is envisioned that any given embodiment of the systems and methods within the scope of this disclosure may use triggers in the form of barcodes, plain text user entries, NFC transmissions, WiFi transmissions, short wave radio transmissions (e.g., Bluetooth), light modulations, sound modulations. etc. Moreover, as one of ordinary skill in the art understands, a matrix barcode is an optical machine-readable label that may be associated with data such as data representative of a TOP survey. An exemplary matrix barcode may include black modules (square dots) arranged in a square grid on a white background. The information encoded by the barcode may be comprised of four standardized types of data (numeric, alphanumeric, byte/binary, Kanji) or, through supported extensions, virtually any type of data. As one of ordinary skill in the art further understands, a matrix barcode may be read by an imaging device, such as a camera, and formatted algorithmically by underlying software using error correction algorithms until the image can be appropriately interpreted. Data represented by the barcode is then extracted from patterns present in both horizontal and vertical components of the image.

Reference is made in this description to “pushing” survey content. Survey content, and responses triggered by survey content, may be “pushed” from a survey server to a PCD or from a PCD to a survey server, as the case may be. Thus, one of ordinary skill in the art will recognize that the use herein of “push” or “pushing” to describe survey content being delivered to a consumer's PCD includes not only cases where a survey server causes content under its control to be transmitted to a PCD, but also cases where a PCD using a browser application or other means may request content from the survey server. Moreover, one of ordinary skill in the art will recognize that in this description “pushing” content may alternatively be the result of content transmitted between a survey server and PCD by any means including, but not limited to, short messaging service (“SMS”), WiFi, short wave radio, cellular transmissions, Internet protocol, etc. Further, depending on the embodiment, content may be “pushed” between a PCD and one or more other components such as a point of sale (“POS”) system, survey server, etc.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” “wireless handset” and portable computing device (“PCD”) are used interchangeably. With the advent of third generation (“3G”) and fourth generation (“4G”) wireless technology, greater bandwidth availability has enabled more portable computing devices with a greater variety of wireless capabilities. Therefore, a portable computing device (“PCD”) may include a cellular telephone, a pager, a PDA, a smartphone, a navigation device, a tablet personal computer (“PC”), or a hand-held computer with a wireless connection or link.

Embodiments of the systems and methods provide for the conducting of consumer surveys during the checkout process at a retail establishment, i.e. a time of purchase (“TOP”) survey. Once the checkout process has begun, there is often a period of time for the consumer as he waits for a retail clerk to complete the process of scanning the items for purchase and tallying a total amount owed. Embodiments of the systems and methods seek to recognize this downtime or idle time so that a consumer survey may be conducted with the consumer.

The advantages of various embodiments of systems and methods for providing TOP surveys are numerous. For example, because the consumer is near in time with the shopping experience, the feedback provided by a consumer while waiting in the checkout line is fresh from the consumer's mind and may be more accurate than feedback provided by other methods known in the art. Also, because the consumer is likely unencumbered by other demands on his time, participation rates in a survey conducted during the checkout procedure may be higher than participation rates in surveys provisioned through other methods.

Additionally, certain embodiments for conducting TOP surveys may recognize the nature of goods being purchased in the transaction and dynamically customize survey questions as the checkout process develops. For example, a first question of an exemplary survey may be triggered before any items are scanned for purchase and may be a general question: “On a scale of 1 to 10 how did you find the in-store shopping experience?” The exemplary embodiment may then recognize that a certain brand of headphones, for example, has been scanned at the point of sale (“POS”) by the clerk and subsequently push a survey question to the consumer that is triggered by such recognition: “Did you need assistance in finding where the headphones where located in the store?” Similarly, it is envisioned that certain embodiments may recognize specific items being scanned, such as the exemplary headphones, and subsequently push a survey question to the consumer according to the wishes of the manufacturer of the headphones (or any interested third party such as, but not limited to, a competitive manufacturer, a manufacturer of complimentary goods, a marketing firm, etc.): “What was the primary reason that you selected Brand X headphones?”.

Returning to the exemplary dynamic TOP survey that may be pushed to a consumer during the checkout process by some embodiments, the nature of an answer to a question asking about the consumer's experience with assistance in the headphone aisle of the store may be used to dictate the next survey question: “Were you happy with the assistance provided?” Similarly, the answer to that question may be used by the retail store to immediately address issues with, or positively reinforce habits of, the personnel responsible for providing assistance in the headphone aisle. In this way, the near real time feedback captured by certain embodiments may be leveraged by retail store management to improve future customer shopping experiences.

As another non-limiting example of a TOP survey that may be conducted by embodiments of the systems and methods, survey content may be pushed to a consumer during the processing of returning goods. Advantageously, information collected from consumers when returning goods may be very valuable for improving advertising, marketing, product features, etc. Moreover, information related to new goods or services actually purchased in a transaction that includes the return or refund for other goods or services may be valuable to retailers and manufacturer's alike.

It is envisioned that certain embodiments may include systems and methods for estimating the checkout process duration. For example, it is envisioned that camera systems may be used by some embodiments to recognize the relative amounts and types of goods being purchased in the transaction and, from such recognition, calculate how long the checkout process is likely to take. Other embodiments may use weight scales to gauge the amount of goods and correlate the measurement to an estimated checkout duration. Still other embodiments may use ID tags on shopping carts and/or handheld shopping baskets to estimate a checkout time based on the amount of goods that could be carried in the cart or basket. Other systems and methods for estimating a checkout time for the purpose of calculating the amount of time available to push a TOP survey to a consumer will occur to those with ordinary skill in the art and, although certain such systems and methods may be novel in and of themselves, the inclusion or exclusion of any specific system or method for estimating the checkout duration will not be limiting on the scope of a system or method for provisioning a TOP survey.

From a checkout time estimate, certain embodiments may build a TOP survey that includes prioritized content. For example, recognition that a particular consumer engaged in the checkout process has ten items for purchase, seven with bar codes (such as a bag of chips, for example) and three that must be weighed (such as fresh produce, for example), an exemplary embodiment may determine that there will be thirty (30) seconds of downtime for the consumer as the retail clerk scans the items and totals the transaction. Based on such knowledge, the embodiment may build a TOP survey of three questions, for example, thereby allotting the consumer ten seconds per question to receive the question and respond. Recognizing that there will likely be only time for three questions, the embodiment may choose high priority questions set by the retail store. Other embodiments may choose to recognize actual items of the ten which are being scanned and then push specific questions directed to those items.

Still other embodiments may not include systems or methods for estimating checkout time and may simply begin pushing survey content to the consumer upon recognizing that the consumer is in the checkout process. Like other embodiments, such embodiments that do not include a checkout duration estimate may still include features for determining survey content dynamically based on the items being purchased during the transaction, purchasing history of the consumer, preferred customer status of the consumer, time of day, etc.

An exemplary embodiment may include the presentation of a quick response (“QR”) code or some other machine readable trigger at the POS (e.g. transmissions via NFC, Bluetooth, WiFi, Light modulation, Sound modulation, etc.). Upon being presented with the QR code, the consumer may scan it with a QR reader application on his PCD. As is understood by one of ordinary skill in the art, the QR reader application may use the scanned QR code to direct a web browser application in the PCD to a mobile website that contains a TOP survey application. As is further understood by one of ordinary skill in the art, some PCDs may include a QR code scanner application in the operating system of the PCD. Regardless, by using the provided QR code, the PCD may direct the consumer to a website hosted by a survey server for filling out a TOP survey. The consumer may then use the PCD as an interface to the survey server, pushing survey content between the survey server and PCD during the checkout process. As described above, the survey content within the TOP survey may be predetermined or may be driven by the purchasing history of the consumer or by the actual items being purchased during the transaction.

In another exemplary embodiment, a QR code that is unique to the transaction may be presented to the consumer. In such an embodiment, the consumer may present a loyalty token to the retail clerk so that the unique QR code may be linked to the consumer, the combination of items the consumer is purchasing, the time of day, the historical purchasing patterns of the consumer, etc. In this way, the data associated with the particular consumer through the loyalty program may be queried and used to build and select survey content for the TOP survey. Certain embodiments may use a unique QR code, however, it is envisioned that any means for communicating with the PCD at the POS may be used by certain embodiments for triggering the provision of a TOP survey such as, but not limited to, a Near Field Communication (“NFC”) terminal.

Yet another exemplary embodiment may simply trigger provision of a TOP survey via recognition of a loyalty account at the POS. For example, a consumer may present a loyalty token to a retail clerk who, in turn, enters the loyalty data into the POS. The POS, being in communication with a survey server, provides the loyalty data to the survey server. The survey server queries a PCD phone number associated with the loyalty data and sends an SMS message (i.e., a “text” message) to the PCD with a uniform resource locator (“URL”) link to a TOP survey. The consumer may then use his PCD, as is understood by one of ordinary skill in the art, to access the TOP survey via the link. Similar embodiments may simply “text” survey content back and forth between the survey server and the PCD via SMS. The survey content of the TOP survey may be predetermined or dynamically determined according to any one or more of the various algorithms described herein.

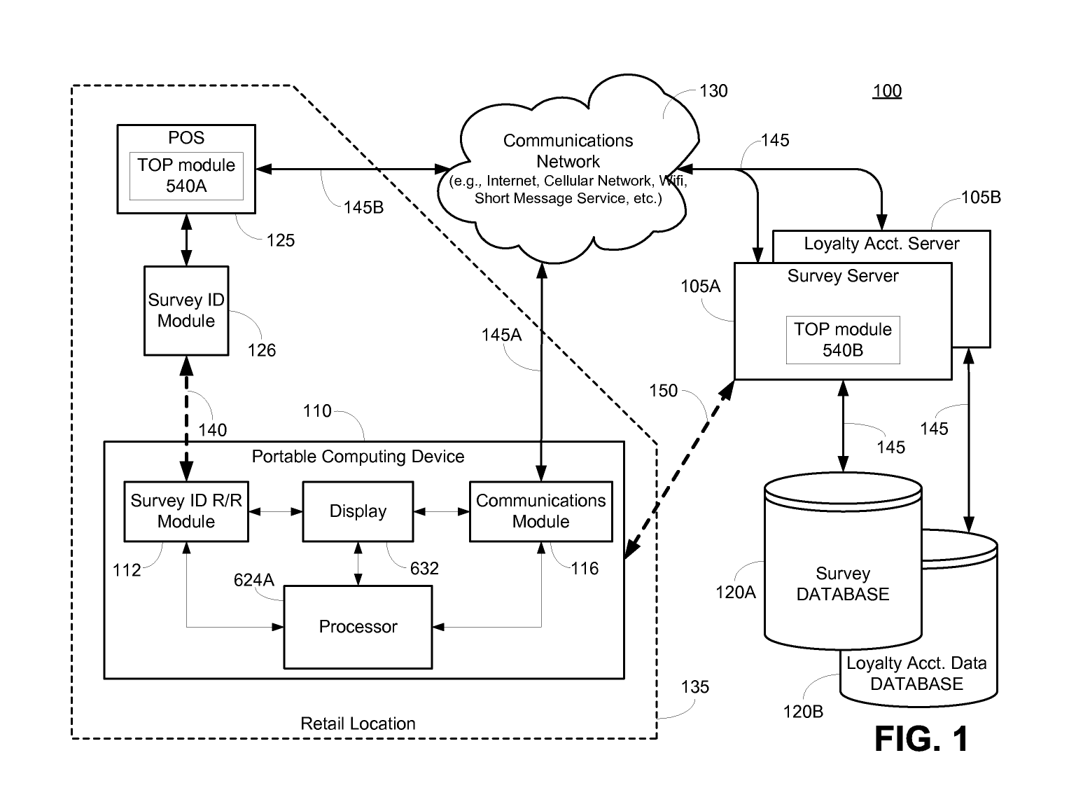

Referring to FIG. 1, a high level diagram illustrates exemplary components of a system 100 for provisioning a time of purchase (“TOP”) survey to a consumer in a retail location 135. The illustrated components of the exemplary system 100 use a survey ID module 126 near, or integral to, a point of sale (“POS”) module 125 for presenting a survey ID (such as a QR code) to a consumer.

Embodiments of a system 100 for provisioning a TOP survey to a consumer in a retail proximity 135 has many potential advantages. Briefly, and to provide the basis for an exemplary, non-limiting application scenario in which aspects of some embodiments of the disclosed systems and methods may be suitably described, consider a consumer with a loyalty account associated with a retailer. The ability to gather feedback from the consumer regarding the items he is purchasing, or the items he has purchased in the past, or the items he might be returning, or his shopping experience is valuable information for the retailer, as it opens up unique opportunities for the retailer to improve product offerings, identify areas for service improvement, target marketing efforts to the preferences of the consumer, etc.

To further the example, the retailer establishment, such as a storefront or other “brick and mortar” location, may be represented by retail proximity 135. A consumer associated with a loyalty account of the retailer, proceeds to checkout after shopping in the retailer's store 135. The consumer carries a cellular telephone, i.e. a portable computing device 110, running a survey ID reader and router module 112. The POS 125 recognizing that the consumer is in the process of completing the purchase transaction (i.e., the clerk is scanning items for purchase) uses survey ID module 126 to present a survey ID to the consumer. Notably, the presented survey ID may be unique to the specific purchase transaction in some embodiments.

The consumer may then use the PCD 110 to “read” the survey ID as presented by the survey ID module 126 via communication 140 with survey ID reader/router module 112. Based on the survey ID, the processor 624 may use communications module 116 to establish communications with survey server 105A. For example, as is understood by one of ordinary skill in the art, Survey ID R/R module 112 may read a QR code presented by survey ID module 126 to direct a browser application in PCD 110 to a URL hosted by survey server 105A.

Once in communication with survey server 105A, the PCD 110 may render survey content via display 632. The survey server 105A, being in communication with PCD 110 and/or POS 125 via networks 130 may have knowledge of the loyalty account data associated with the consumer and/or knowledge of the particular items being scanned at POS 125 for purchase. The survey server 105A may have knowledge of the loyalty account data by virtue of communication with a loyalty account server 105B which manages and provides loyalty account data stored in loyalty account data database 120B. Notably, as one of ordinary skill in the art will recognize, the survey server 105A and the loyalty account server 105B may be one and the same or may be separate, mutually exclusive servers. Similarly, the survey database 120A and the loyalty account database 120B may be a single database or may be separate databases.

The TOP module 540B in the survey server 105A may cause a query of the survey database 120A to identify survey content and push it to the consumer via PCD 110. The consumer may then respond to the survey content, the responses being recorded by the TOP module 540B of the survey server 105A in survey database 120A. The exchange of survey content, questions and answers, between survey server 105A (via TOP module 540B) and the consumer (via PCD 110) may continue until the checkout process is completed, however, it is envisioned that in some embodiments the TOP survey may continue until the consumer stops participating or there is no more survey content to push.

Various exemplary embodiments of the systems and methods are described herein such that the TOP module 540B in the survey server 105A performs the various steps of pushing TOP survey content to, and receiving TOP survey content from, the PCD 110. It is also described herein that the TOP module 540B performs other aspects in the provisioning of a TOP survey such as, but not limited to, communicating with the POS 125 to recognize items being scanned for purchase, querying database 120 for survey content, loyalty account data, etc., executing algorithms for selection of top survey content and updating database 120. Notably, it is also envisioned that the various functions described herein, whether explicitly or inherently described, relative to the TOP module 540B in survey server 105A may also be performed by a TOP module 540A in POS 125 in some embodiments. That is, it is envisioned that the provisioning of a TOP survey may be accomplished in some embodiments by a TOP module 540A integrated within a POS 125 and in communication with a database 120A.

Turning back to the FIG. 1 illustration, exemplary embodiments of a PCD 110 envision remote communication, real-time software updates, extended data storage, etc. and may be leveraged in various configurations by users of system 100. Advantageously, embodiments of PCDs 110 configured for communication via a computer system such as the exemplary system 100 depicted in FIG. 1 may leverage communications networks 130 including, but not limited to cellular networks, PSTNs, cable networks and the Internet for, among other things, software upgrades, content updates, database queries, data transmission, etc. Other data that may be used in connection with a PCD 110, and accessible via the Internet or other networked system, will occur to one of ordinary skill in the art.

The illustrated computer system 100 may comprise a server 105 that may be coupled to a network 130 comprising any or all of a wide area network (“WAN”), a local area network (“LAN”), the Internet, or a combination of other types of networks.

It should be understood that the term server 105 may refer to a single server system or multiple systems or multiple servers. The server 105 may be coupled to a data/service survey database 120B. The data/service survey database 120B may store various records related to, but not limited to, PCD user-specific contact or account information, historical content, purchase transaction duration estimation algorithms, filters/rules algorithms, survey content, previously recorded feedback, etc.

When the server 105 is coupled to the network 130, the server 105 may communicate through the network 130 with various different PCDs 110 associated customers of a retailer. Each PCD 110 may run or execute web browsing software or functionality to access the server 105 and its various survey applications including TOP module 540B. Any device that may access the network 130 either directly or via a tether to a complimentary device, may be a PCD 110 according to the computer system 100. The PCDs 110, as well as other components within system 100 such as, but not limited to, a wireless router (not shown), may be coupled to the network 130 by various types of communication links 145. These communication links 145 may comprise wired as well as wireless links. The communication links 145 allow a PCD 110 to establish virtual links 150 with the server 105. While a virtual link 150 is depicted between the server 105, an actual wired or wireless link 140 may exist between the PCD 110 and the POS 125 via survey ID module 126. This link 140 may only be used to relay the survey ID (e.g., QR code) to the PCD 110 as a uni-directional communications channel. In other exemplary embodiments, the PCD 110 may establish bi-directional communications with the POS 125 as understood by one of ordinary skill in the art and thereby provide communication with survey server 105A via POS 125.

A PCD 110 may include a display 632, a processor 624 and a communications module 116 that may include one or more of a wired and/or wireless communication hardware and a radio transceiver 117. It is envisioned that the display 632 may comprise any type of display device such as a liquid crystal display (“LCD”), a plasma display, an organic light-emitting diode (“OLED”) display, a touch activated display, and a cathode ray tube (“CRT”) display, a brail display, an LED bank, and a segmented display. A PCD 110 may execute, run or interface to a multimedia platform that may be part of a plug-in for an Internet web browser.

The communications module 116 may comprise wireless communication hardware such as, but not limited to, a WiFi card or NFC card for interfacing with survey ID module 126. Further, the communications module 116 may include a cellular radio transceiver to transmit survey ID information and survey content as well as other information to exemplary survey server 105A, as depicted in the system 100 embodiment. One of ordinary skill in the art will recognize that a communications module 116 may include application program interfaces to processor 624.

It is envisioned that a PCD 110 may be configured to leverage the cellular radio transceiver of the communications module 116 to transmit data, such as a survey content by way of a secure channel using wireless link 145A to the survey server 105A. It is also envisioned that PCD 110 in some exemplary embodiments of system 100 may leverage communication link 145B via communication link 140 that may be established between the POS 125 and PCD 110 to transmit data to and from survey server 105A.

Communication links 145A, 145 and 140, in general, may comprise any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network.

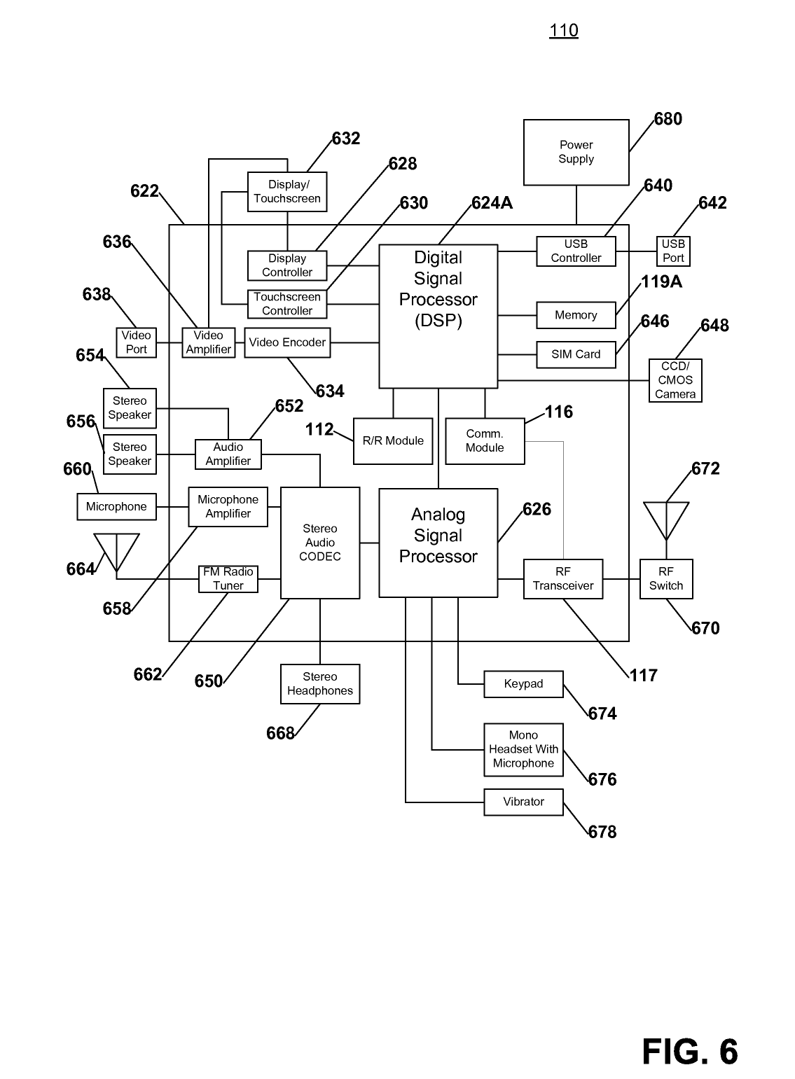

An exemplary PCD 110 may also comprise a computer readable storage/memory component 119A (shown in FIG. 6) for storing, whether temporarily or permanently, various data including, but not limited to, survey content. Data added to, extracted or derived from the survey ID or loyalty account data may comprise a consumer ID, a transaction ID, a directory number (“DN”) or calling line ID (“CLID”) associated with PCD 110, a retailer ID, a hash value, a codec key, encryption or decryption data, account numbers and other account related data, etc.

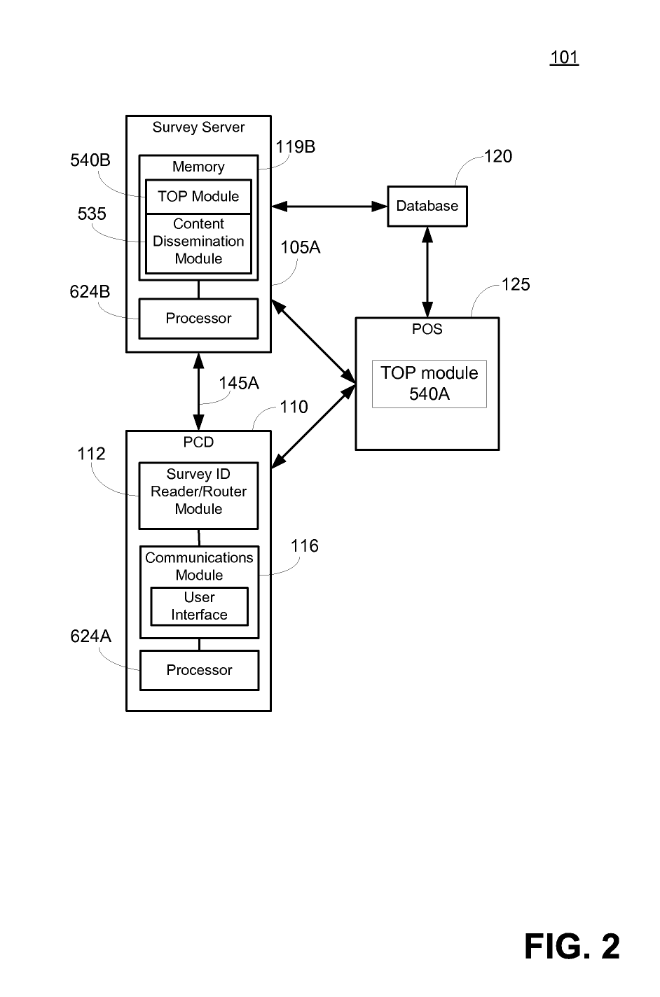

Turning now to FIG. 2, a diagram of exemplary computer architecture 101 for the system 100 of FIG. 1 is depicted. The exemplary architecture 101 may include a portable computing device (“PCD”) 110. A survey server 105A may be connected to the PCD 110. The survey server 105A may be connected to the PCD 110 via a communications link 145A, such as a mobile telephone network. Further, the survey server 105A may be connected to a POS 125 via a communications link 145B, such as by a LAN. As noted previously, it should be understood that the term server 105 may refer to a single server system or multiple systems or multiple servers. One of ordinary skill in the art will appreciate that the various server arrangements may be selected depending upon computer architecture design constraints and without departing from the scope of the invention.

As illustrated in FIG. 2, the PCD 110 may include a processor 624A, a memory 119A (see FIG. 6), a survey ID R/R module 112 and a communications module 116 coupled to the processor 624A. The memory 119A may include instructions for executing one or more of the method steps described herein. Further, the processor 624A and the memory 119A may serve as a means for executing one or more of the method steps described herein. A survey ID R/R module 112 operates to recognize a survey ID for establishing communications with survey server 105A, thereby providing survey server 105A with a means for pushing TOP survey content to a consumer associated with PCD 110.

FIG. 2 shows that the survey server 105A may include a processor 624B and a memory 119B coupled to the processor 624B. The memory 119B may include instructions for executing one or more of the method steps described herein. Further, the processor 624B and the memory 119B may serve as a means for executing one or more of the method steps described herein. As illustrated, the memory 119B may include a survey content determination module that works with, or as part of, the TOP module 540B to query database 120A and determine survey content, such as survey questions, to be pushed to PCD 110. Further, as illustrated, the memory 119B may include a Content Dissemination (“CD”) module 535 that works with, or as a part of, the TOP module 540B to transmit various survey contents to PCD 110.

A merchant's point of sale (“POS”) system 125 may also be connected to the survey server 105A such that PCD-user transaction data may be tracked and transmitted to the survey server 105A. Notably, as described above, the POS 125 in some embodiments may include its own TOP module 540A. Also, in some embodiments, a wireless router (not shown) may be operable to provide a communication link through POS 125 to survey server 105A. Advantageously, embodiments that include a communication link to survey server 105A through POS 125 may provide a PCD 110 with an alternate communication path to survey server 105A, thus potentially alleviating the need for communication link 145A.

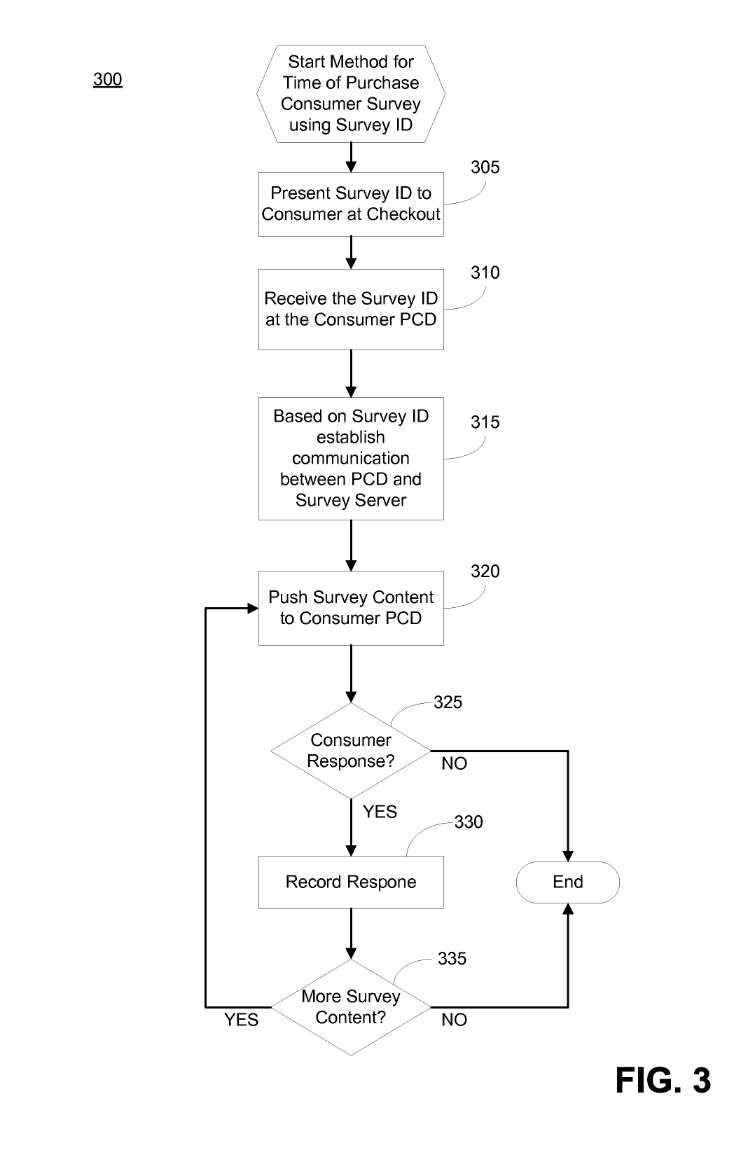

FIG. 3 illustrates an exemplary method 300 for provisioning a time of purchase (“TOP”) survey to a consumer during a checkout procedure in a retail location. Beginning at block 305, a consumer is presented with a survey ID, such as a QR code. Notably, and as described above, the survey ID may be used to trigger the consumer's participation in a TOP survey process. Presumably, to be presented with the survey ID, the consumer has completed shopping and is in the process of “checking out” such that a clerk is scanning items for purchase.

At block 310, the consumer may scan the survey ID with a PCD 110. At block 315, scanning the survey ID causes PCD 110 to establish communications with a survey server 105A, such as via a URL as is understood by one of ordinary skill in the art. Subsequently, at block 320 the survey server 105A may query database 120A to select and push TOP survey content back to the PCD 110. At decision block 325, if the consumer does not respond, then the “no” branch is followed in the method and the TOP survey ends. If the consumer does respond to the pushed survey content, then the “yes” branch is followed to block 330 and the survey server records the response in database 120A. Once the survey response is recorded at block 330, then the method proceeds to decision block 335 and the survey server 105A determines if there is additional content to be pushed to PCD 110. Notably, the selection and determination of survey content to push to PCD 110 may be determined by algorithms residing in memory 119B and executed by TOP module 540 and processor 550B (see FIG. 2).

Returning to the FIG. 3 method at decision block 335, if the survey server 105A determines that there is additional survey content to push to PCD 110, then the “yes” branch is followed back to block 320 and the method continues. If the survey server 105A determines that there is no additional content to push to PCD 110, then the “no” branch is followed from decision block 335 and the method 300 ends. Notably, it is envisioned that in some embodiments a TOP survey method may also end as a result of the completion of the checkout process. That is, the TOP survey may end when the POS 125 indicates to the survey server 105A that all items to be purchased by the consumer have been scanned and the consumer, therefore, must complete the purchase transaction via payment.

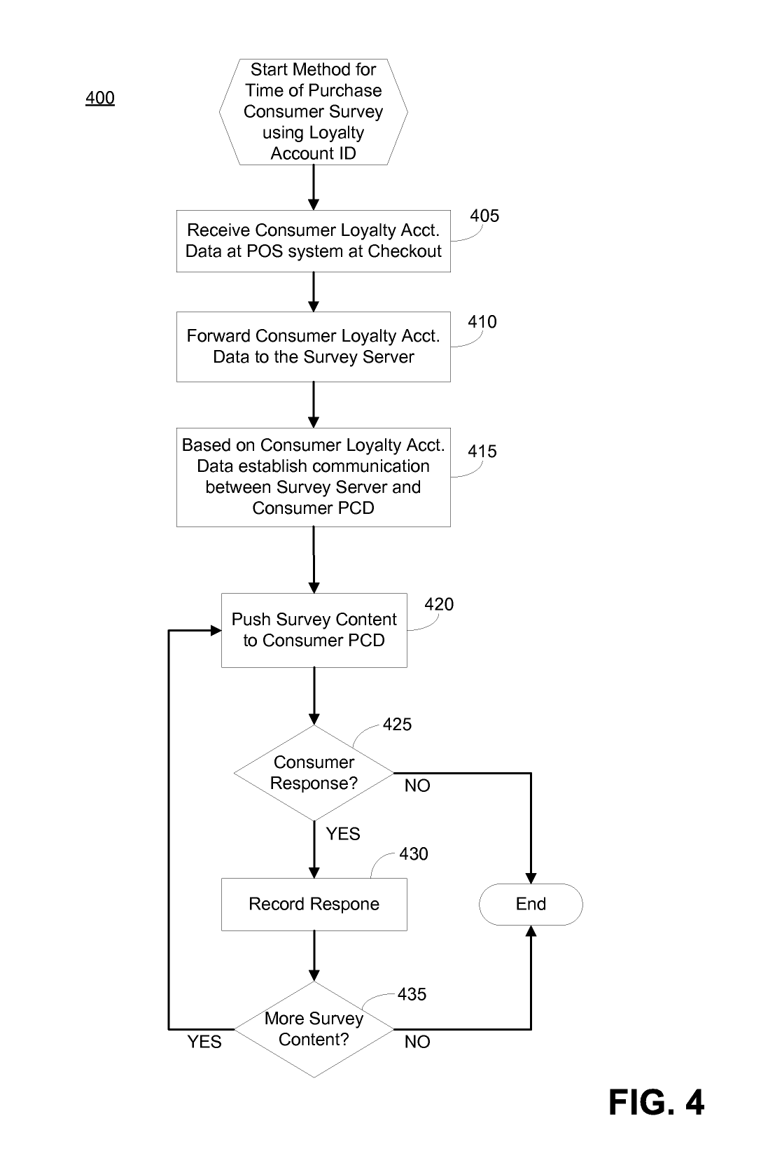

FIG. 4 illustrates an exemplary method 400 for provisioning a time of purchase (“TOP”) survey to a consumer with an associated loyalty account during a checkout procedure in a retail location. Beginning at block 405, at the time of checkout a consumer associated with a PCD 110 may present consumer loyalty data, such as a consumer loyalty token, to a POS system 125. Notably, as one of ordinary skill in the art will understand, the consumer may present the loyalty account data to the survey server 105A via POS 125 or, in some embodiments, the consumer may use the PCD 110 to directly contact the survey server 105A and provide the loyalty account data at that time. As described above, using a QR code trigger is one way for the PCD 110 to initiate contact with the survey server 105A. Alternatively, and because the loyalty account data may include a phone number associated with the PCD 110, the survey server 105A may initiate contact with the PCD 110, such as via an SMS communication.

Returning to the method 400, at block 410 the consumer loyalty account data is transmitted to the survey server 105A and, based on the data, the survey server 105A establishes communication with the PCD 110. Notably, some embodiments may include customer historical purchasing data and be tied to feedback on previous surveys to be leveraged in this TOP survey.

At block 420 the survey server 105A may query database 120A to select and push TOP survey content back to the PCD 110. The survey content may be selected based on the loyalty account data, data associated with items being scanned for purchase by POS 125, predetermined survey content, feedback from previously pushed survey content, or a combination thereof. At decision block 425, if the consumer does not respond, then the “no” branch is followed in the method and the TOP survey ends. If the consumer does respond to the pushed survey content, then the “yes” branch is followed to block 430 and the survey server records the response in database 120A. Once the survey response is recorded at block 430, then the method proceeds to decision block 435 and the survey server 105A determines if there is additional content to be pushed to PCD 110. Notably, the selection and determination of survey content to push to PCD 110 may be determined by algorithms residing in memory 119B and executed by TOP module 540 and processor 550B (see FIG. 2).

Returning to the FIG. 4 method at decision block 435, if the survey server 105A determines that there is additional survey content to push to PCD 110, then the “yes” branch is followed back to block 420 and the method continues. If the survey server 105A determines that there is no additional content to push to PCD 110, then the “no” branch is followed from decision block 435 and the method 400 ends. Notably, it is envisioned that in some embodiments a TOP survey method may also end as a result of the completion of the checkout process. That is, the TOP survey may end when the POS 125 indicates to the survey server 105A that all items to be purchased by the consumer have been scanned and the consumer, therefore, must complete the purchase transaction via payment.

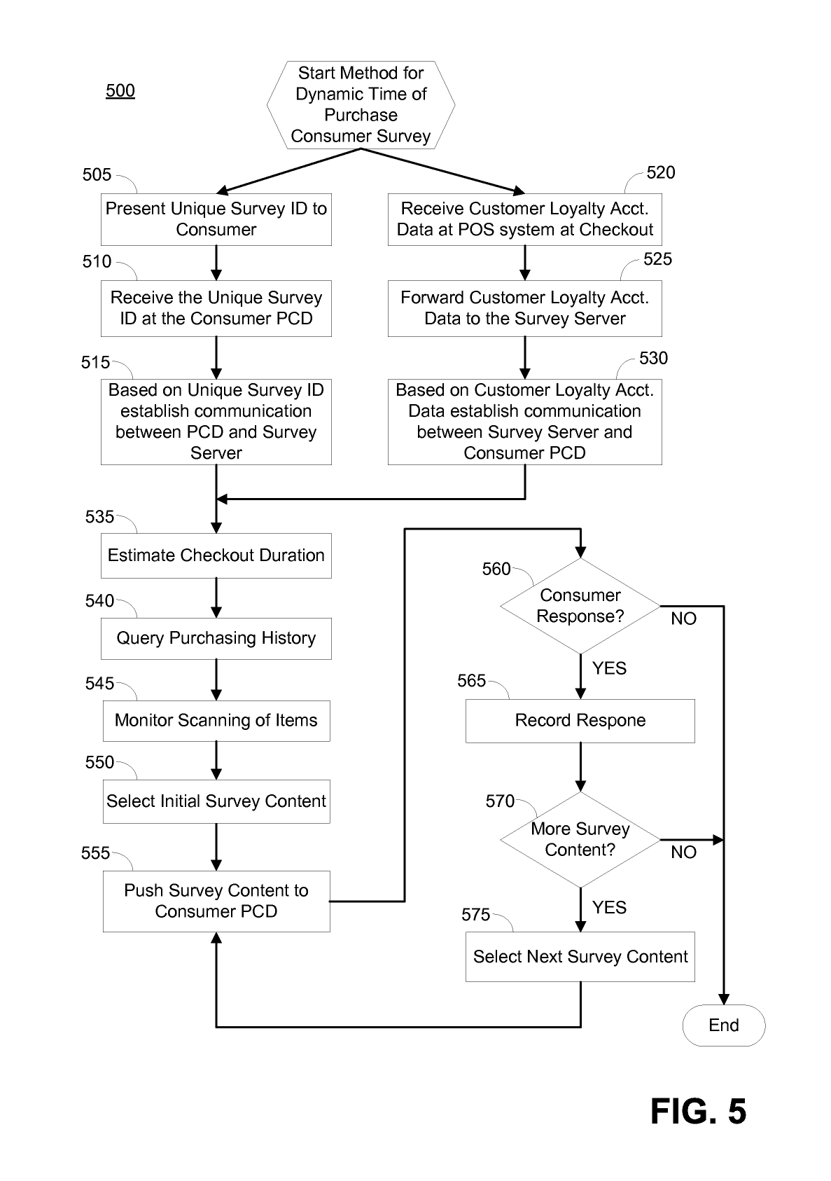

FIG. 5 illustrates an exemplary method 500 for provisioning a dynamic time of purchase (“TOP”) survey to a consumer during a checkout procedure in a retail location. Beginning at block 505, a unique survey ID is presented to the consumer. The unique survey ID may be unique to the purchase transaction. At block 510, the unique survey ID, such as a unique QR code, is received by the PCD 110 of the consumer and used at block 515 to establish communication with a survey server 105A, as is understood by one of ordinary skill in the art.

Returning to the beginning of the method 500, blocks 505-515 may be substituted with blocks 520-530 in some embodiments of the systems and methods. Beginning at block 520, the consumer may present loyalty account data to a POS 125 of the retailer. The loyalty account data may be forwarded to the survey server at block 525 and used at block 530 to establish communication with PCD 110 of the consumer. As described above, a phone number associated with PCD 110 may be readily identifiable via query of database 120B for the loyalty account data and the communication between survey server 105A and PCD 110 may be established via an SMS transmission that includes an embedded web link.

From either of blocks 515 or 530, the method 500 proceeds to block 535. At block 535, the survey server via POS 125 may estimate the time that it will take for the clerk to scan all items to be purchased and total the transaction for payment. While the clerk scans the items, embodiments of the system and method may push TOP survey content to the PCD 110 and record consumer feedback. It is envisioned that certain embodiments will use the checkout duration estimation to select TOP survey content with algorithms that consider priority of survey content. As described above, the checkout duration estimation may be accomplished by using any number of systems and methods including, but not limited to, cameras, weight scales, NFC tags, item counters, manual estimations made by the clerk or the consumer, etc.

Returning to the method 500, at block 540 the survey server 105A may use the loyalty account data to query purchasing history data associated with the consumer. Consequently, TOP survey content selection algorithms executed by the survey server 105A may select survey content based on such purchasing history. At block 545, the POS 125 may monitor scanned items and relay such information to the survey server 105A. Advantageously, by monitoring the items being scanned and transmitting the data to the survey server, TOP survey content selection algorithms executed by the survey server 105A may select survey content directed to the items that are being purchased by the consumer.

Based on at least information relative to blocks 535-545, at block 550 an initial survey content may be selected and pushed to the PCD 110 at block 555. At decision block 560, if the consumer does not respond to the pushed survey content, then the “no” branch is followed and the method 500 ends. If the consumer does respond to the pushed survey content, then the “yes” branch is followed from decision block 560 to block 565 and the response is recorded in database 120A.

Subsequently, at decision block 570, the survey server 105A determines if more survey content is available. If “yes” then the method 500 proceeds to block 575 and a next survey content is selected from the database 120A. As described above, the next survey content may be selected based on feedback provided in answer to a previously pushed survey content, for example. The process 500 returns to block 555 and the next selected content is pushed to the consumer via PCD 110. If no more survey content is identified at block 570, then the “no” branch is followed and the method 500 ends. Notably, it is envisioned that in some embodiments a TOP survey method may also end as a result of the completion of the checkout process. That is, the TOP survey may end when the POS 125 indicates to the survey server 105A that all items to be purchased by the consumer have been scanned and the consumer, therefore, must complete the purchase transaction via payment.

Referring to FIG. 6, this figure is a diagram of an exemplary, non-limiting aspect of a PCD 110 comprising a wireless telephone which corresponds with FIG. 1 and FIG. 2. As shown, the PCD 110 includes an on-chip system 622 that includes a digital signal processor 624 and an analog signal processor 626 that are coupled together. As illustrated in FIG. 6, a display controller 628 and a touchscreen controller 630 are coupled to the digital signal processor 624. A touchscreen display 632 external to the on-chip system 622 is coupled to the display controller 628 and the touchscreen controller 630.

FIG. 6 further indicates that a video encoder 634, e.g., a phase-alternating line (“PAL”) encoder, a sequential couleur avec memoire (“SECAM”) encoder, a national television system(s) committee (“NTSC”) encoder or any other video encoder, is coupled to the digital signal processor 624. Further, a video amplifier 636 is coupled to the video encoder 634 and the touchscreen display 632. A video port 638 is coupled to the video amplifier 636. A universal serial bus (“USB”) controller 640 is coupled to the digital signal processor 624. Also, a USB port 642 is coupled to the USB controller 640. A memory 119A and a subscriber identity module (“SIM”) card 646 may also be coupled to the digital signal processor 624. Further, a digital camera 648 may be coupled to the digital signal processor 624. In an exemplary aspect, the digital camera 648 is a charge-coupled device (“CCD”) camera or a complementary metal-oxide semiconductor (“CMOS”) camera.

As further illustrated in FIG. 6, a stereo audio CODEC 650 may be coupled to the analog signal processor 626. Moreover, an audio amplifier 652 may be coupled to the stereo audio CODEC 650. In an exemplary aspect, a first stereo speaker 654 and a second stereo speaker 656 are coupled to the audio amplifier 652. FIG. 6 shows that a microphone amplifier 658 may be also coupled to the stereo audio CODEC 650. Additionally, a microphone 660 may be coupled to the microphone amplifier 658. In a particular aspect, a frequency modulation (“FM”) radio tuner 662 may be coupled to the stereo audio CODEC 650. Also, an FM antenna 664 is coupled to the FM radio tuner 662. Further, stereo headphones 368 may be coupled to the stereo audio CODEC 650.

FIG. 6 further indicates that a radio frequency (“RF”) transceiver 117 may be coupled to the analog signal processor 626. An RF switch 670 may be coupled to the RF transceiver 117 and an RF antenna 672. As shown in FIG. 6, a keypad 674 may be coupled to the analog signal processor 626. Also, a mono headset with a microphone 676 may be coupled to the analog signal processor 626.

Further, a vibrator device 678 may be coupled to the analog signal processor 626. Also shown is that a power supply 680 may be coupled to the on-chip system 622. In a particular aspect, the power supply 680 is a direct current (“DC”) power supply that provides power to the various components of the PCD 110 that require power. Further, in a particular aspect, the power supply is a rechargeable DC battery or a DC power supply that is derived from an alternating current (“AC”) to DC transformer that is connected to an AC power source.

FIG. 6 also shows that the PCD 110 may include a survey ID reader/router module 112 and a communications module 116. As described above, the survey ID reader/router module 112 may be operable work with the RF antenna 672 and transceiver 117 to establish communication with a survey server 105A and/or a POS 125.

As depicted in FIG. 6, the touchscreen display 632, the video port 638, the USB port 642, the camera 648, the first stereo speaker 654, the second stereo speaker 656, the microphone 660, the FM antenna 664, the stereo headphones 668, the RF switch 670, the RF antenna 672, the keypad 674, the mono headset 676, the vibrator 678, and the power supply 680 are external to the on-chip system 622.

In a particular aspect, one or more of the method steps described herein may be stored in the memory 119A as computer program instructions. These instructions may be executed by the digital signal processor 624, the analog signal processor 626, or another processor, to perform the methods described herein. Further, the processors, 624, 626, the memory 119A, the instructions stored therein, or a combination thereof may serve as a means for performing one or more of the method steps described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Also, in some instances, multiple actions depicted and described as unique steps in the present disclosure may be comprised within a single step. Further, words such as “thereafter”, “then”, “next”, “subsequently”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for conducting a consumer survey during a checkout process at a retailer location with a consumer who is associated with a portable computing device (“PCD”), comprising:
presenting a survey ID embedded in a machine readable code to the consumer during the checkout process, wherein the survey ID is associated with a time of purchase (“TOP”) survey;
based on the survey ID, initiating provision of the TOP survey;
selecting a first survey content associated with the TOP survey;
pushing the first survey content associated with the TOP survey to the consumer;
receiving a response to the pushed first survey content;
storing the received response to the first survey content; and
determining that the checkout process has concluded.

2. The method of claim 1, further comprising:
selecting a second survey content associated with the TOP survey;
pushing the second survey content to the consumer;
receiving a response to the pushed second survey content; and
storing the received response to the second survey content.

3. The method of claim 2, further comprising:
identifying an item that has been scanned during the checkout process; and
selecting the second survey content based on the item.

4. The method of claim 3, further comprising:
selecting a third survey content associated with the TOP survey based on the response to the pushed second survey content;
pushing the third survey content to the consumer;
receiving a response to the pushed third survey content; and
storing the received response to the third survey content.

5. The method of claim 1, wherein the machine readable code is one of a QR code, NFC transmission, WiFi transmission, Bluetooth transmission, Light modulation, and Sound Modulation.

6. The method of claim 1, further comprising:
estimating a duration for the checkout process; and
based on the estimation, selecting survey content associated with the TOP survey.

7. The method of claim 6, wherein the duration is estimated based on a number of items being scanned in the checkout process.

8. The method of claim 6, wherein the duration is estimated based on the weight of items being scanned in the checkout process.

9. The method of claim 1, further comprising:
receiving identification of a consumer loyalty account; and
selecting the first survey content based on data associated with the consumer loyalty account.

10. The method of claim 1, wherein the checkout process comprises scanning one or more items that are being returned to the retailer.

11. A system for conducting a consumer survey during a checkout process at a retailer location with a consumer who is associated with a portable computing device (“PCD”), comprising:
a survey server that comprises a time of purchase (“TOP”) module configured to:
present a survey ID embedded in a machine readable code to the consumer during the checkout process, wherein the survey ID is associated with a TOP survey;
based on the survey ID, initiate provision of the TOP survey;
select a first survey content associated with the TOP survey;
push the first survey content associated with the TOP survey to the consumer;
receive a response to the pushed first survey content;
store the received response to the first survey content; and
determine that the checkout process has concluded.

12. The system of claim 11, wherein the TOP module is further configured to:
select a second survey content associated with the TOP survey;
push the second survey content to the consumer;
receive a response to the pushed second survey content; and
store the received response to the second survey content.

13. The system of claim 12, wherein the TOP module is further configured to:
identify an item that has been scanned during the checkout process; and
select the second survey content based on the item.

14. The system of claim 13, wherein the TOP module is further configured to:
select a third survey content associated with the TOP survey based on the response to the pushed second survey content;
push the third survey content to the consumer;
receive a response to the pushed third survey content; and
store the received response to the third survey content.

15. The system of claim 11, wherein the machine readable code is one of a QR code, NFC transmission, WiFi transmission, Bluetooth transmission, Light modulation, and Sound Modulation.

16. The system of claim 11, wherein the TOP module is further configured to:
estimate a duration for the checkout process; and
based on the estimation, select survey content associated with the TOP survey.

17. The system of claim 16, wherein the duration is estimated based on a number of items being scanned in the checkout process.

18. The system of claim 16, wherein the duration is estimated based on the weight of items being scanned in the checkout process.

19. The system of claim 11, wherein the TOP module is further configured to:
receive identification of a consumer loyalty account; and
select the first survey content based on data associated with the consumer loyalty account.

20. The system of claim 11, wherein the checkout process comprises scanning one or more items that are being returned to the retailer.

21. A system for conducting a consumer survey during a checkout process at a retailer location with a consumer who is associated with a portable computing device (“PCD”), comprising:
means for presenting a survey ID embedded in a machine readable code to the consumer during the checkout process, wherein the survey ID is associated with a time of purchase (“TOP”) survey;
means for initiating provision of the TOP survey based on the survey ID;
means for selecting a first survey content associated with the TOP survey;
means for pushing the first survey content associated with the TOP survey to the consumer;
means for receiving a response to the pushed first survey content;
means for storing the received response to the first survey content; and
means for determining that the checkout process has concluded.

22. The system of claim 21, further comprising:
means for selecting a second survey content associated with the TOP survey;
means for pushing the second survey content to the consumer;
means for receiving a response to the pushed second survey content; and
means for storing the received response to the second survey content.

23. The system of claim 22, further comprising:
means for identifying an item that has been scanned during the checkout process; and
means for selecting the second survey content based on the item.

24. The system of claim 23, further comprising:
means for selecting a third survey content associated with the TOP survey based on the response to the pushed second survey content;
means for pushing the third survey content to the consumer;
means for receiving a response to the pushed third survey content; and
means for storing the received response to the third survey content.

25. The system of claim 21, wherein the machine readable code is one of a QR code, NFC transmission, WiFi transmission, Bluetooth transmission, Light modulation, and Sound Modulation.

26. The system of claim 21, further comprising:
means for estimating a duration for the checkout process; and
means for selecting survey content associated with the TOP survey based on the estimation.

27. The system of claim 26, wherein the duration is estimated based on a number of items being scanned in the checkout process.

28. The system of claim 26, wherein the duration is estimated based on the weight of items being scanned in the checkout process.

29. The system of claim 21, further comprising:
means for receiving identification of a consumer loyalty account; and
means for selecting the first survey content based on data associated with the consumer loyalty account.

30. The system of claim 21, wherein the checkout process comprises scanning one or more items that are being returned to the retailer.

31. A computer program product comprising a computer usable device having a computer readable program code embodied therein, said computer readable program code executable to implement a method for conducting a consumer survey during a checkout process at a retailer location with a consumer who is associated with a portable computing device (“PCD”), comprising:
presenting a survey ID embedded in a machine readable code to the consumer during the checkout process, wherein the survey ID is associated with a time of purchase (“TOP”) survey;
based on the survey ID, initiating provision of the TOP survey;
selecting a first survey content associated with the TOP survey;
pushing the first survey content associated with the TOP survey to the consumer;
receiving a response to the pushed first survey content;
storing the received response to the first survey content; and
determining that the checkout process has concluded.

32. The computer program product of claim 31, further comprising:
selecting a second survey content associated with the TOP survey;
pushing the second survey content to the consumer;
receiving a response to the pushed second survey content; and
storing the received response to the second survey content.

33. The computer program product of claim 32, further comprising:
identifying an item that has been scanned during the checkout process; and
selecting the second survey content based on the item.

34. The computer program product of claim 33, further comprising:
selecting a third survey content associated with the TOP survey based on the response to the pushed second survey content;
pushing the third survey content to the consumer;
receiving a response to the pushed third survey content; and
storing the received response to the third survey content.

35. The computer program product of claim 31, wherein the machine readable code is one of a QR code, NFC transmission, WiFi transmission, Bluetooth transmission, Light modulation, and Sound Modulation.

36. The computer program product of claim 31, further comprising:
estimating a duration for the checkout process; and
based on the estimation, selecting survey content associated with the TOP survey.

37. The computer program product of claim 36, wherein the duration is estimated based on a number of items being scanned in the checkout process.

38. The computer program product of claim 36, wherein the duration is estimated based on the weight of items being scanned in the checkout process.

39. The computer program product of claim 31, further comprising:
receiving identification of a consumer loyalty account; and
selecting the first survey content based on data associated with the consumer loyalty account.

40. The computer program product of claim 31, wherein the checkout process comprises scanning one or more items that are being returned to the retailer.
